(19) United States
(12) Patent Application Publication
(10) Pub. No.: US 2026/0086353 A1
(43) Pub. Date: Mar. 26, 2026

(54) VIRTUAL IMAGE DISPLAY APPARATUS AND OPTICAL UNIT

(71) Applicant: SEIKO EPSON CORPORATION, Tokyo (JP)

(72) Inventor: Mitsutaka IDE, SHIOJIRI-SHI (JP)

(73) Assignee: SEIKO EPSON CORPORATION, Tokyo (JP)

(21) Appl. No.: 19/340,808

(22) Filed: Sep. 25, 2025

(30) Foreign Application Priority Data
Sep. 26, 2024 (JP) 2024-166998

(51) Int. Cl. G02B 27/00; G02B 27/01; G02B 27/28

(52) U.S. Cl. CPC G02B 27/0018; G02B 27/0172; G02B 27/283; G02B 2027/0178

(57) ABSTRACT

A direct virtual image-type virtual image display apparatus includes a display element, a first prism, a second prism bonded to the first prism, a semi-transmissive reflection film disposed in a junction portion between the first prism and the second prism, a first lens disposed so as to face an outer side surface of the first prism, a transmissive mirror formed at the first lens and configured to reflect a part of the image light reflected by the semi-transmissive reflection film, and a quarter-wave plate disposed between the outer side surface of the first prism and the first lens. In the prism-based light guide member, a third surface in contact with a first surface and a second surface facing the first lens is configured to be inclined with a first plane that is a virtual plane perpendicular to a first direction in which eyes of a wearer are arranged.

The present application is based on, and claims priority from JP Application Serial Number 2024-166998, filed Sep. 26, 2024, the disclosure of which is hereby incorporated by reference herein in its entirety.

### BACKGROUND

### 1. Technical Field

The present disclosure relates to a see-through virtual image display apparatus and an optical unit that enable observation of a virtual image.

### 2. Related Art

There is publicly known a head-mounted display apparatus including an image display device and an optical system that includes a concave mirror and a semi-transmissive element and projects an image formed by the image display device onto a retina of a user sequentially through the semi-transmissive element, the concave mirror, the semi-transmissive element, and an exit pupil of the apparatus, and characterized in further including a first lens disposed between the image display device and the semi-transmissive element to collimate light generated by the image display device with respect to the optical system (see JP-T-2003-502710).

JP-T-2003-502710 is an example of the related art.

In the head-mounted display device described above, since the intermediate image is not generated and the optical diaphragm is not present, unnecessary light unnecessary for displaying the image such as ghost or stray light is confined inside the optical system and reaches the eyes.

### SUMMARY

A virtual image display apparatus in one aspect of the present disclosure is a direct virtual image-type virtual image display apparatus including a display element configured to emit image light, a first prism on which the image light from the display element is incident, a second prism bonded to the first prism to form a prism-based light guide member having a parallel flat plate shape, a semi-transmissive reflection film disposed in a junction portion between the first prism and the second prism and configured to reflect the image light guided in the first prism, a first lens having a planoconvex shape and disposed so as to face an outer side surface of the first prism on which the image light reflected by the semi-transmissive reflection film is incident, a transmissive mirror formed at a convex surface of the first lens and configured to reflect, toward the semi-transmissive reflection film, a part of the image light reflected by the semi-transmissive reflection film, and a quarter-wave plate disposed between the outer side surface of the first prism and the first lens with an air gap, in which out of surfaces of the prism-based light guide member, a third surface in contact with a first surface on which the image light from the display element is incident and a second surface facing the first lens is configured to be inclined at a constant angle with a first plane that is a virtual plane perpendicular to a first direction in which eyes of a wearer who wears the virtual image display apparatus are arranged, in a direction in which the prism-based light guide member is configured to be tapered toward a direction from the eyes of the wearer toward the first lens along an optical axis of the first lens.

An optical unit in one aspect according to the present disclosure is a direct virtual image-type optical unit including a display element configured to emit image light, a first prism on which the image light from the display element is incident, a second prism bonded to the first prism to form a prism-based light guide member having a parallel flat plate shape, a semi-transmissive reflection film disposed in a junction portion between the first prism and the second prism and configured to reflect the image light guided in the first prism, a first lens having a planoconvex shape and disposed so as to face an outer side surface of the first prism on which the image light reflected by the semi-transmissive reflection film is incident, a transmissive mirror formed at a convex surface of the first lens and configured to reflect, toward the semi-transmissive reflection film, a part of the image light reflected by the semi-transmissive reflection film, and a quarter-wave plate disposed between the outer side surface of the first prism and the first lens with an air gap, in which out of surfaces of the prism-based light guide member, a third surface in contact with a first surface on which the image light from the display element is incident and a second surface facing the first lens is configured to be inclined at a constant angle with a first plane that is a virtual plane perpendicular to a first direction in which eyes of a wearer who wears the optical unit are arranged, in a direction in which the prism-based light guide member is configured to be tapered toward a direction from the eyes of the wearer toward the first lens along an optical axis of the first lens.

### BRIEF DESCRIPTION OF THE DRAWINGS

FIG. 1 is an appearance diagram illustrating a use situation of a virtual image display apparatus according to a first embodiment.

FIG. 2 is a side cross-sectional view illustrating an internal structure of the display apparatus on one side.

FIG. 3 is a conceptual perspective view of a virtual image display apparatus according to related art.

FIG. 4 is a conceptual cross-sectional view of the virtual image display apparatus according to the related art.

FIG. 5 is a conceptual perspective view of the virtual image display apparatus according to the first embodiment.

FIG. 6 is a conceptual cross-sectional view of the virtual image display apparatus according to the first embodiment.

FIG. 7 is a diagram showing luminance distributions of image light and unnecessary light observed by an eye when the virtual image display apparatus according to the related art is used.

FIG. 8 is a diagram showing luminance distributions of image light and unnecessary light observed by an eye when the virtual image display apparatus according to the related art is used.

FIG. 9 is a diagram showing luminance distributions of image light and unnecessary light observed by an eye when the virtual image display apparatus according to the related art is used.

FIG. 10 is a diagram showing luminance distributions of image light and unnecessary light observed by an eye when the virtual image display apparatus according to the first embodiment is used.

FIG. 11 is a diagram showing luminance distributions of image light and unnecessary light observed by an eye when the virtual image display apparatus according to the first embodiment is used.

FIG. 12 is a diagram showing luminance distributions of image light and unnecessary light observed by an eye when the virtual image display apparatus according to the first embodiment is used.

FIG. 13 is a conceptual perspective view of a virtual image display apparatus according to a second embodiment.

FIG. 14 is a conceptual cross-sectional view of the virtual image display apparatus according to the second embodiment.

### DESCRIPTION OF EMBODIMENTS

### First Embodiment

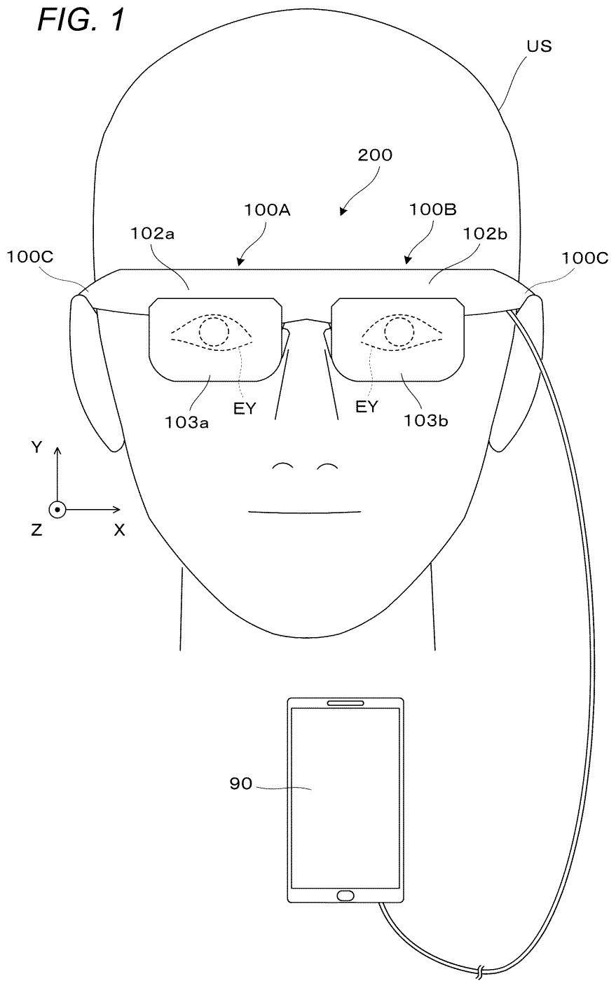

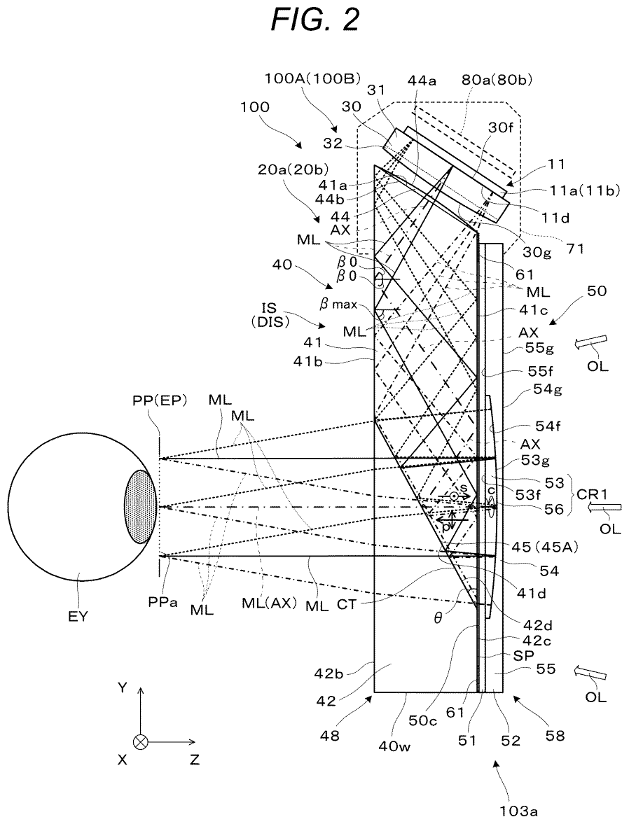

A first embodiment of a virtual image display apparatus and so on according to the present disclosure will hereinafter be described with reference to FIGS. 1, 2, and so on.

FIG. 1 is a diagram illustrating a mounted state of a head-mounted virtual image display apparatus (hereinafter, also referred to as a head-mounted display or an HMD) 200, and the HMD 200 causes an observer or a wearer US who wears the head-mounted virtual image display apparatus to recognize an image as a virtual image. In FIG. 1 and so on, X, Y, and Z represent axes of an orthogonal coordinate system, a +X direction corresponds to a lateral direction in which both eyes EY of the observer or the wearer US wearing the HMD 200 are arranged, a +Y direction corresponds to an upward direction for the wearer US and orthogonal to the lateral direction in which both eyes EY are arranged, and a +Z direction corresponds to a forward direction or a frontward direction for the wearer US. The ±Y directions are made parallel to a vertical axis or a vertical direction.

The HMD 200 includes a direct virtual image-type first virtual image display apparatus 100A for a right eye, a direct virtual image-type second virtual image display apparatus 100B for a left eye, a pair of temple-shaped support devices 100C for supporting the virtual image display apparatus 100A, 100B, and a user terminal 90 as an information terminal. The first virtual image display apparatus 100A independently functions as an HMD, and includes a first display driver 102a disposed at an upper portion of the first virtual image display apparatus 100A and a first combiner 103a which is shaped like a spectacle lens and covers the front side of the eye. Similarly, the second virtual image display apparatus 100B independently functions as an HMD and includes a second display driver 102b disposed at an upper portion of the second virtual image display apparatus 100B and a second combiner 103b which is shaped like a spectacle lens and covers the front side of the eye. The pair of support devices 100C are each a mounting member mounted on the head of the wearer US, and support upper ends of the pair of combiners 103a, 103b via the display drivers 102a, 102b integrated with each other in appearance. The first virtual image display apparatus 100A and the second virtual image display apparatus 100B are optically the same or horizontally inverted, and detailed description of the second virtual image display apparatus 100B will be omitted.

FIG. 2 is a side cross-sectional view illustrating an internal structure of the first virtual image display apparatus 100A. The first virtual image display apparatus 100A includes a first image forming element 11a, a first display unit 20a, and a first circuit member 80a. The first image forming element 11a is also referred to as a display element 11. The first display unit 20a is an imaging optical system IS that directly forms a virtual image without forming an intermediate image, and is also referred to as a direct virtual image optical system DIS. The imaging optical system IS includes a first lens 30, a first flat-plate member 40, and a second flat-plate member 50. The first lens 30 has a function as a protective glass that protects a display surface 11d of the display element 11. The first flat-plate member 40 includes a third lens 44 facing the first lens 30. The first flat-plate member 40 guides the image light ML emitted from the display element 11 and incident from the third lens 44 to a second lens 53 of the second flat-plate member 50. The second flat-plate member 50 partially directs the image light ML incident from the first flat-plate member 40 back to the first flat-plate member 40 to thereby reflect the image light ML toward a pupil position PP or the eye EY, and causes external light OL to be incident on the pupil position PP via the first flat-plate member 40. The first lens 30, the third lens 44, the first flat-plate member 40, and the second flat-plate member 50 each have a function as a lens having positive refractive power.

Although not described in detail, the second virtual image display apparatus 100B includes a second image forming element 11b, a second display unit 20b, and a second circuit member 80b. The second image forming element 11b is substantially the same as the first image forming element 11a, the second display unit 20b is substantially the same as the first display unit 20a, and the second circuit member 80b is substantially the same as the first circuit member 80a.

In the first virtual image display apparatus 100A, the first image forming element 11a is a self-luminous image light generator. The first image forming element 11a outputs the image light ML to the first flat-plate member 40 via the first lens 30. The first image forming element 11a is housed in and supported by an enclosure 71. The first image forming element 11a is, for example, an organic electroluminescence (Organic Electro-Luminescence (EL)) display, and forms a color still image or color moving image on a two-dimensional display surface 11d. The first image forming element 11a is driven by the first circuit member 80a to perform a display operation. The first image forming element 11a is not limited to an organic EL display, and can be replaced with a display device using inorganic EL, an organic LED, an LED array, a laser array, a quantum dot luminous element, or the like. The first image forming element 11a is not limited to a self-luminous image light generator, and may be a device which is configured with a light modulation element such as an LCD and forms an image by illuminating the light modulation element with a light source such as a backlight. As the first image forming element 11a, a liquid crystal on silicon (LCOS, LCoS is a registered trademark), a digital micromirror device, or the like can be used in place of the LCD. Note that an optical apparatus obtained by excluding the first circuit member 80a from the first virtual image display apparatus 100A is referred to as an optical unit 100. It can be said that the optical unit 100 is a portion which includes a direct virtual image-type optical system and corresponds to a direct virtual image optical system DIS constituting the first virtual image display apparatus 100A.

The first display unit 20a includes the first lens 30, the first flat-plate member 40, a polarization separation film 45A as a semi-transmissive reflection film 45, and the second flat-plate member 50. In the first display unit 20a, the first lens 30 has positive refractive power, and the image light ML from the first image forming element 11a enters the first lens 30. The first lens 30 has a plane of incidence of light 30f as a flat surface to be bonded to the first image forming element 11a, and a light exit surface 30g as a convex surface. The light exit surface 30g is, for example, a spherical surface, and may be an aspherical surface having an axisymmetric shape. The first lens 30 can be conceptually divided into a parallel flat plate 31 and a lens portion 32. Foreign matter having adhered to the surface of the first lens 30 becomes inconspicuous by ensuring the thickness of the parallel flat plate 31 no smaller than a predetermined value. The lens portion 32 is a planoconvex lens having positive refractive power. One surface of the planoconvex lens has a planar shape, and the other surface thereof has a convex shape. The first lens 30 is made of, for example, fused quartz and is relatively low in refractive index.

The first flat-plate member 40 includes the third lens 44 as a planoconvex lens, a first prism 41 shaped like a parallel flat plate, and a second prism 42 shaped like a parallel flat plate. The third lens 44 and the first prism 41 are bonded to each other at inclined surfaces 44b and 41a. The first prism 41 and the second prism 42 are bonded to each other at inclined surfaces 41d, 42d. What is obtained by bonding the third lens 44, the first prism 41, and the second prism 42 to each other is referred to as a prism-based light guide member 48. The prism-based light guide member 48 has an appearance of a parallel flat plate. The polarization separation film 45A as the semi-transmissive reflection film 45, which is a flat surface, is formed at the inclined surface 41d formed at a lower side of the first prism 41. What is obtained by combining the prism-based light guide member 48 and the second flat-plate member 50 described later with each other corresponds to the first combiner 103a shown in FIG. 1.

The third lens 44 is the planoconvex lens having a positive refractive index, and includes an optical plane of incidence 44a facing the light exit surface 30g of the first lens 30, and the inclined surface 44b coupled to the first prism 41. The optical plane of incidence 44a is a convex surface such as a spherical surface, and may instead be an axisymmetric aspherical surface. The third lens 44 is made of, for example, fused quartz and is relatively low in refractive index. The third lens 44 has an equivalent refractive index to that of the first lens 30.

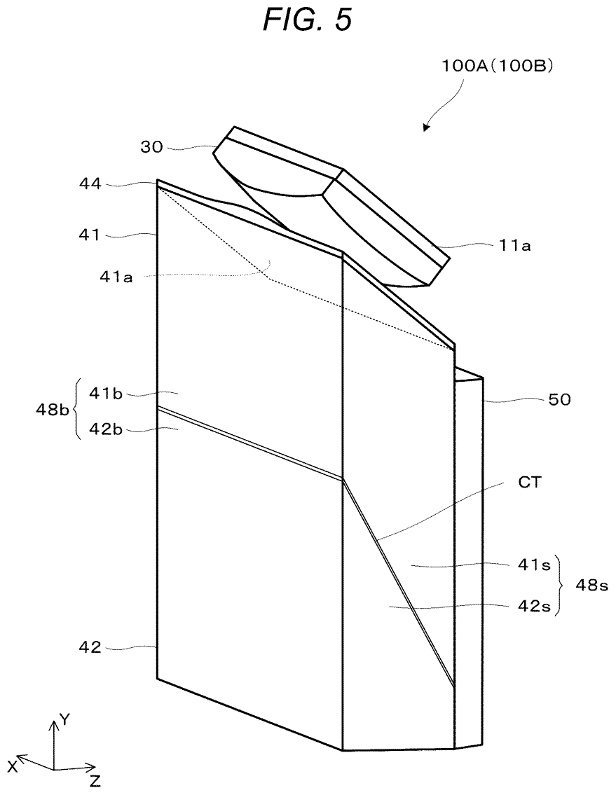

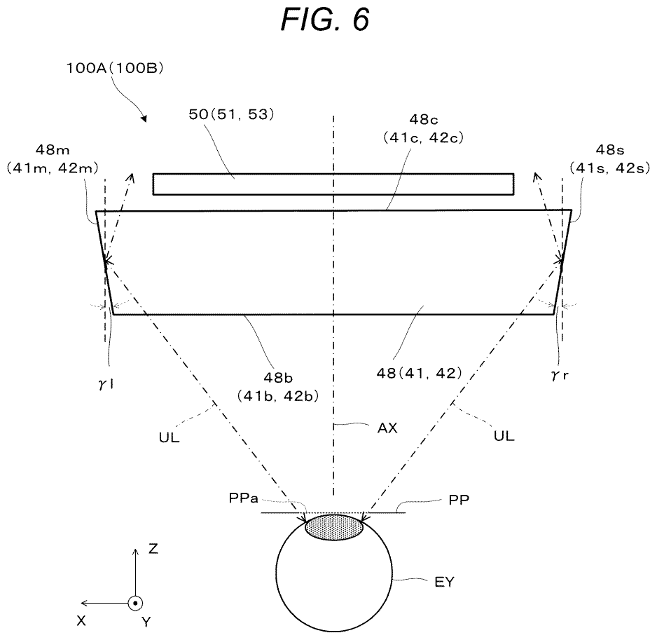

The first prism 41 has the inclined surface 41a coupled to the inclined surface 44b of the third lens 44, an inner side surface 41b, an outer side surface 41c, and the inclined surface 41d. The first prism 41 further includes a right side surface 41s and a left side surface 41m described later (see FIGS. 5 and 6). The first prism 41 has a quadrangular prismatic outer shape having the inclined surface 41a, the inner side surface 41b, the outer side surface 41c, and the inclined surface 41d as side surfaces, and has a trapezoidal vertical cross section in which the inner side surface 41b and the outer side surface 41c are the parallel base sides in a cross section along the Y-Z plane when viewed from the X-axis direction. The first prism 41 guides the image light ML incident from the inclined surface 41a until the image light ML is emitted from the outer side surface 41c after being reflected by the inner side surface 41b, the outer side surface 41c, and the inclined surface 41d. Here, the inclined surface 41a inclines downward on the front side thereof as a whole, and an optical axis passing through the inclined surface 41a extends in a direction between the +Z direction as a frontward direction, and the +Y direction as an upward direction. Thus, it becomes easy to dispose the first image forming element 11a as the display element 11 at an external side of the inner side surface 41b, and thus, it is possible to adjust an angle at which the image light ML is made to propagate in the first prism 41 (in the first prism 41 or through the inside of the first prism 41). The inner side surface 41b and the outer side surface 41c are parallel to each other and extend in a direction perpendicular to an optical axis AX between the pupil position PP, and the inner side surface 41b and the outer side surface 41c. The inner side surface 41b and the outer side surface 41c are for internally reflecting the image light ML (i.e., reflecting the image light ML at inner side of an object surface), and are particularly preferable for totally reflecting the image light ML. The scratch resistance or scuff resistance of the inner side surface 41b can be enhanced by being provided with a hard coat. The inclined surface 41d is a flat surface. The inclined surface 41d is at an acute angle with the outer side surface 41c, specifically an angle in a range from 25° to 32°. Note that a distance between the optical axis AX passing through the pupil position PP and the first lens 30 is about 20 mm. The first prism 41 is formed of glass or a resin material, and has a refractive index higher than the refractive index of the first lens 30.

Basically, the number of times of reflection of the image light ML in the first prism 41 is one at the inner side surface 41b, one at the outer side surface 41c, and further, one at the polarization separation film 45A described later. By setting the number of times of internal reflection of the image light ML in the first prism 41 to two, it is possible to avoid mixture of light different in number of times of reflection in the first prism 41 while increasing a field angle of the image light ML, and the pupil position PP or an aperture PPa at the pupil position PP. The image light ML to be reflected by the inner side surface 41b and the outer side surface 41c enters the inner side surface 41b and the outer side surface 41c in a diverging state and the diverging state is maintained although a degree of divergence is suppressed compared to the original diverging state at the time of being emitted from the first image forming element 11a since an intermediate image is not formed in the first display unit 20a or the imaging optical system IS. Here, the diverging state of the image light ML means a state in which an area occupied by the image light ML in a certain virtual plane orthogonal to the optical axis gradually increases as the image light ML travels along the optical axis. In addition, the degree of divergence of the image light ML is suppressed to at least such an extent that the image light ML falls within the first prism 41 including before and after the reflection by the inner side surface 41b and the outer side surface 41c in any virtual plane orthogonal to the optical axis.

Similarly to the first prism 41, the second prism 42 has a quadrangular prismatic outer shape and has a trapezoidal longitudinal cross-section. More specifically, the second prism 42 has an inner side surface 42b, an outer side surface 42c, the inclined surface 42d, and a lower flat surface 42w, and has a quadrangular prismatic outer shape having the inner side surface 42b, the outer side surface 42c, the inclined surface 42d, and the lower flat surface 42w as side surfaces, and has a trapezoidal vertical cross section in which the inner side surface 42b and the outer side surface 42c are the parallel base sides in a cross section along the Y-Z plane when viewed from the X-axis direction. The second prism 42 further includes a right side surface 42s and a left side surface 42m described later (see FIGS. 5 and 6). The second prism 42 transmits the image light ML incident from the inclined surface 42d and emits the image light ML from the inner side surface 42b. The inner side surface 42b and the outer side surface 42c are parallel to each other and extend in a direction perpendicular to an optical axis AX between the pupil position PP, and the inner side surface 42b and the outer side surface 42c. The scratch resistance or scuff resistance of the inner side surface 42b can be enhanced by being provided with a hard coat. The second prism 42 is formed of glass or a resin material, and has a refractive index equal to the refractive index of the first prism 41.

The polarization separation film 45A is integrally formed at the inclined surface 41d of the first prism 41 to be sandwiched between the inclined surface 41d of the first prism 41 and the inclined surface 42d of the second prism 42. A space between the polarization separation film 45A and the inclined surface 42d is filled with an adhesive CT for bonding purposes. The polarization separation film 45A is configured with a dielectric multilayer film, efficiently reflects the image light ML as s-polarized light s when the image light ML contains the s-polarized light s, and efficiently transmits the image light ML as p-polarized light p when the image light ML contains the p-polarized light p. The polarization separation film 45A is only required to selectively reflect the image light ML in accordance with the polarization direction of the image light ML, and may be, for example, a wire grid. It is sufficient for the polarization separation film 45A to be a surface flat enough not to affect imaging. Further, the polarization separation film 45A may have a minute convexly or concavely curved surface to the extent that the image formation is not affected. The scratch resistance or scuff resistance of the polarization separation film 45A can be enhanced by providing the surface thereof with a hard coat. Note that a space between the polarization separation film 45A and the inclined surface 41d may be filled with a filler having a transmissive property in place of the adhesive CT. In this case, the first prism 41 and the second prism 42 may be supported by a support member or the like from outside to maintain the bonded state. Further, the polarization separation film 45A may integrally be formed at the inclined surface 42d of the second prism 42 instead of the inclined surface 41d of the first prism 41.

An inclination angle θ of the polarization separation film 45A with respect to the X-Y plane is 90°-β0 or more when defining a reflection angle of the image light ML on the optical axis AX in the first prism 41 as β0. As a premise that the polarization separation film 45A does not block the path of the image light ML, the inclination angle θ of the polarization separation film 45A is desirably smaller than βmax when defining the maximum reflection angle of the image light ML as βmax. The reflection angle β0 of the image light ML corresponds to an angle between the normal line of the inner side surface 41b and the optical axis AX passing through the optical plane of incidence 44a, and is an acute angle. That is, the optical axis AX of the optical plane of incidence 44a extends in a direction at an angle less than 90° with the normal line of the inner side surface 41b.

The second flat-plate member 50 includes a quarter-wave plate 51 shaped like a thin plate, and a cover member 52. The quarter-wave plate 51 is a crystal or the like having an optical axis between the X direction and the Y direction, and converts the image light ML as the s-polarized light s reflected by the polarization separation film 45A into circularly polarized light c, and converts the image light ML as the circularly polarized light c reflected by the cover member 52 into the p-polarized light p. The quarter-wave plate 51 is disposed between the outer side surface 41c of the first prism 41 and the second lens 53 with an air gap. The cover member 52 includes the second lens 53 as a planoconvex lens, a compensation lens 54 as a planoconcave lens, a compensation flat plate 55 disposed on the periphery of the compensation lens 54 and extending in parallel to the prism-based light guide member 48, and a transmissive mirror 56.

The second flat-plate member 50 is disposed at a distance in a range from about 20 μm to 50 μm from the first flat-plate member 40. There is a possibility that the outer side surfaces 41c, 42c of the first flat-plate member 40 and an inner side surface 50c of the second flat-plate member 50 is slightly curved, so that a minute step is formed on the boundary between the outer side surfaces 41c, 42c, but it is possible to prevent these surfaces from coming excessively close to each other by setting the distance between the outer side surfaces 41c, 42c and the inner side surface 50c to no less than 20 μm, more preferably, no less than 30 μm. Conversely, by setting the distance between the outer side surfaces 41c, 42c and the inner side surface 50c to no more than 50 μm, it is possible to prevent the thickness of the first combiner 103a having the first flat-plate member 40 and the second flat-plate member 50 combined with each other from increasing. A spacer 61 for adjusting the distance between the first flat-plate member 40 and the second flat-plate member 50 and fixing the first flat-plate member 40 and the second flat-plate member 50 in a state in which the first flat-plate member 40 and the second flat-plate member 50 are positioned with each other is disposed between the outer side surfaces 41c, 42c of the first flat-plate member 40 and the inner side surface 50c of the second flat-plate member 50. The spacer 61 is not provided over the entire circumference of the second flat-plate member 50. That is, a gap SP between the first flat-plate member 40 and the second flat-plate member 50 is not sealed but communicates with the outside.

In the cover member 52, the second lens 53 is thin but has positive refractive power, and has a flat surface 53f bonded to the quarter-wave plate 51 and a convex surface 53g facing the compensation lens 54. The convex surface 53g is, for example, a spherical surface, and may be an axisymmetric aspherical surface. The compensation lens 54 is thin but has positive refractive power, and has a concave surface 54f facing the second lens 53 and a flat surface 54g. The compensation flat plate 55 is a parallel flat plate and has a pair of flat surfaces 55f and 55g. Here, the concave surface 54f of the compensation lens 54 has the same shape as the shape of the convex surface 53g of the second lens 53. The flat surface 54g of the compensation lens 54 and the flat surface 55g of the compensation flat plate 55 are coplanar with each other and are continuous with each other. The transmissive mirror 56 is a thin film formed on the convex surface 53g of the second lens 53, and has the same shape as the shape of the convex surface 53g. A combination of the second lens 53 and the transmissive mirror 56 is referred to as a first light collecting reflector CR.

The second lens 53, the compensation lens 54, and the compensation flat plate 55 are formed of a resin material. The second lens 53, the compensation lens 54, and the compensation flat plate 55 have the same refractive index. The refractive index of the second lens 53 and so on is lower than the refractive index of the first prism 41. The compensation lens 54 and the compensation flat plate 55 are integrally formed of the same resin material into an optical element 58.

A combination of the second lens 53, the compensation lens 54, and the compensation flat plate 55 functions as a parallel flat plate as a whole. That is, the external light OL incident on the surfaces of the compensation lens 54 and the compensation flat plate 55 passes through the compensation lens 54 and the compensation flat plate 55 without being affected by the lens effects provided by the compensation lens 54 and so on and the step located at an outer edge of the compensation lens 54. In this way, the compensation lens 54 optically compensates for the influence of the second lens 53 on the external light OL. In this sense, the flat surface 53f of the second lens 53, the flat surface 54g of the compensation lens 54, and the flat surfaces 55f, 55g of the compensation flat plate 55 are each not necessarily limited to a flat surface in an exact sense, and may each be, for example, a substantially flat surface or may each partially or entirely include a curved surface. In addition, the flat surface 53f of the second lens 53, the flat surface 54g of the compensation lens 54, and the flat surfaces 55f, 55g of the compensation flat plate 55 may each include a curved surface for correcting the eyesight of the wearer US or a curved surface for a good appearance such as that of sunglasses or non-prescribed glasses to the extent that no inconvenience occurs in terms of optical performance. The flat surfaces 54g, 55g of the compensation lens 54 and the compensation flat plate 55 may each be provided with an antireflection film or a hard coat. The external light OL having passed through the compensation flat plate 55 passes through the upper, lower, left, and right sides of the compensation lens 54, and is incident from a peripheral area outside the incident area of the image light ML corresponding to the compensation lens 54, that is, the compensation flat plate 55. Thus, a wide see-through visual field with respect to the outside can be ensured. The visual field range of the external light OL is set to, for example, about 40° in the upward direction and about 40° in the downward direction.

The diameter of the second lens 53 is set in a range of 20 mm to 25 mm from the viewpoint of ensuring the field angle. Note that since the thickness in the Z direction of the first flat-plate member 40 or the prism-based light guide member 48 is in a range of 6 mm to 8 mm, and a distance from the inner side surfaces 41b, 42b of the first flat-plate member 40 to the pupil position PP is in a range of about 12 mm to 13 mm, the field angle (diagonal) that is an angle range in which the image light ML is incident on the pupil position PP can be set to about 40°.

The transmissive mirror 56 is a half mirror, reflects a part of the image light ML having passed through the second lens 53, and transmits a part of the external light OL. The transmissive mirror 56 reflects, toward the pupil position PP, the image light ML which has been reflected by polarization separation film 45A of the first flat-plate member 40 and passed through the quarter-wave plate 51 and the second lens 53. The transmissive mirror 56 is a concave mirror that covers the pupil position PP, at which the eyes EY or the pupils thereof are disposed, has a concave shape toward the pupil position PP, and has a convex shape toward the outside. The pupil position PP or the aperture PPa at the pupil position PP is called an eye point or an eye box, and corresponds to an exit pupil EP of the first display unit 20a.

The transmissive mirror 56 transmits part of the external light OL, and therefore allows see-through viewing of the outside, and can superimpose a virtual image on an external image. On this occasion, the external light OL passes through the first flat-plate member 40 and the second flat-plate member 50, but the flat-plate members 40, 50 do not cause a lens function in the external light OL. The reflectance of the transmissive mirror 56 for the image light ML and the external light OL is set to a value no less than 10% and no more than 50% over an assumed incident angle of the image light ML from the viewpoint of ensuring the luminance of the image light ML and facilitating the observation of the external image due to the see-through viewing. The transmissive mirror 56 is formed of, for example, a dielectric multilayer film configured with a plurality of dielectric layers each having an adjusted film thickness. The transmissive mirror 56 may be a monolayer or multilayer film made of metal such as Al or Ag and having an adjusted film thickness. The transmissive mirror 56 is formed by, for example, evaporation-based lamination.

In the first virtual image display apparatus 100A, the first lens 30, the third lens 44, the second lens 53, and the transmissive mirror 56 each have positive refractive power and provide the diverging light with a converging tendency. The first lens 30, the third lens 44, the second lens 53, and the transmissive mirror 56, including a main body of the first prism 41, the second prism 42, and so on, function as the imaging optical system IS or the direct virtual image optical system DIS such as a monocular microscope that forms an erected image. In such an optical system, an intermediate image is not formed on the optical path, and an image in which the upper, lower, left, and right directions of the observation target are maintained as they are is observed. Thus, it is possible to form a virtual image obtained by projecting a real image formed on the display surface 11d of the first image forming element 11a at infinity, or a virtual image obtained by projecting the real image formed on the display surface 11d at a point several meters ahead. On this occasion, the refractive power of each of the first lens 30, the third lens 44, the second lens 53, and the transmissive mirror 56 is adjusted to shorten the focal length of the imaging optical system IS, so that a desired magnification factor can be achieved.

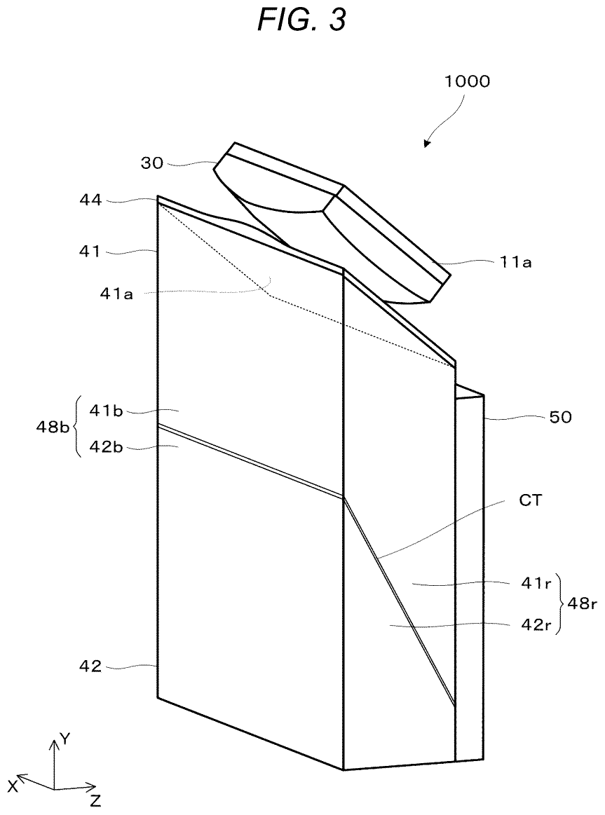

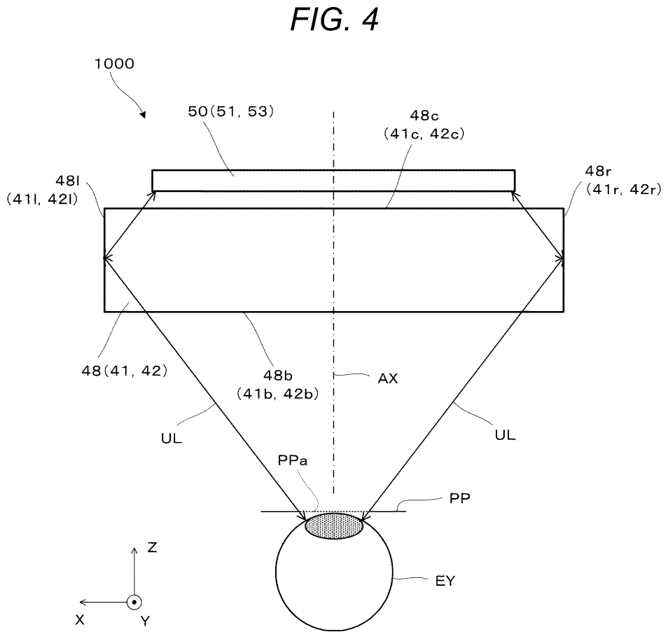

FIG. 3 is a conceptual perspective view of a virtual image display apparatus 1000 according to related art. FIG. 4 is a conceptual cross-sectional view of the virtual image display apparatus 1000 according to the related art illustrated in FIG. 3. When drawing a side cross-sectional view of the virtual image display apparatus 1000 according to the related art illustrated in FIGS. 3 and 4 along the Y-X plane passing through the optical axis AX, the same side cross-sectional view as FIG. 2 is obtained. As shown in FIGS. 3 and 4, in the virtual image display apparatus 1000 according to the related art, a cross section of the prism-based light guide member 48 including the first prism 41 and the second prism 42 along the X-Z plane passing through the optical axis AX of the second lens 53 provided to the second flat-plate member 50 has a rectangular shape. In particular, out of the surfaces of the prism-based light guide member 48, the right side surface 48r in contact with the inclined surface 41a on which the image light ML from the display element 11 is incident and the outer side surface 48c facing the second flat-plate member 50 including the second lens 53 is parallel to the Y-Z plane. Note that the outer side surface 48c of the prism-based light guide member 48 includes the outer side surface 41c of the first prism 41 and the outer side surface 42c of the second prism 42. Similarly, out of the surfaces of the prism-based light guide member 48, the left side surface 48l in contact with the inclined surface 41a and the outer side surface 48c and facing the right side surface 48r is also parallel to the Y-Z plane.

Here, the Y-Z plane is a virtual plane orthogonal to the X-axis direction in which both eyes EY of the wearer US are arranged.

On this occasion, as illustrated in FIG. 4, there is a possibility that the unnecessary light UL from the second flat-plate member 50 enters the prism-based light guide member 48 through the outer side surface 48c, is reflected by the right side surface 48r or the left side surface 48l, is emitted from the prism-based light guide member 48 through the inner side surface 48b, passes through the aperture PPa at the pupil position PP, and reaches the eye EY as ghost, stray light, or the like. Even when the dimensions of the second flat-plate member 50 and the prism-based light guide member 48, the positional relationship of the second flat-plate member 50 and the prism-based light guide member 48 with respect to the eye EY, and so on are determined such that the unnecessary light UL from the second flat-plate member 50 does not reach the eye EY, the center on the X axis of the eye EY may deviate from the optical axis AX of the second lens 53 in some cases. Examples of the reason include when the wearer US rotates the direction of the eyes EY to the left or right, and when the distance between both eyes EY of the wearer US is longer or shorter than an assumed interpupillary distance.

Under such conditions, in order to reduce unnecessary light derived from the image light ML, a method is known in which black paint is applied to at least one of the right side surface 48r and the left side surface 48l so as not to reflect light by absorbing the light. However, when the black paint is applied, a part of the external light OL that should reach the eye EY may be lost due to the black paint.

Therefore, in the virtual image display apparatus 100A, 100B according to an embodiment, the angles of the right side surface 48r and the left side surface 48l in the prism-based light guide member 48 with the Y-Z plane are changed to thereby reduce the unnecessary light UL that reaches the eye EY.

FIG. 5 is a conceptual perspective view of the virtual image display apparatus 100A, 100B according to an embodiment illustrated in FIG. 2. FIG. 6 is a conceptual cross-sectional view of the virtual image display apparatus 100A, 100B illustrated in FIGS. 2 and 5. As illustrated in FIGS. 5 and 6, in the virtual image display apparatus 100A, 100B, a cross section of the prism-based light guide member 48 including the first prism 41 and the second prism 42 along the X-Z plane passing through the optical axis AX of the second lens 53 provided to the second flat-plate member 50 has a trapezoidal shape. In particular, out of the surfaces of the prism-based light guide member 48, the right side surface 48s in contact with the inclined surface 41a on which the image light ML from the display element 11 is incident and the outer side surface 48c facing the second flat-plate member 50 including the second lens 53 is nonparallel to the Y-Z plane and is inclined by an angle γr around a rotational axis parallel to the Y axis. Note that the outer side surface 48c of the prism-based light guide member 48 includes the outer side surface 41c of the first prism 41 and the outer side surface 42c of the second prism 42. Similarly, out of the surfaces of the prism-based light guide member 48, the left side surface 48m in contact with the inclined surface 41a and the outer side surface 48c and facing the right side surface 48s is also nonparallel to the Y-Z plane, and is inclined by an angle γl. As an example, the absolute values of the angle γr and the angle γl may be in a range from 3 degrees to 10 degrees. As another example, the absolute values of the angle γr and the angle γl may be in a range from 3 degrees to 4 degrees. However, the direction of the rotational axis of the inclination is not limited to the Y-axis direction.

Here, the right side surface 48s and the left side surface 48m are inclined at a constant angle with the Y-Z plane in a direction in which the prism-based light guide member 48 is tapered toward the +Z-axis direction. In other words, as shown in FIGS. 3 and 5, when the prism-based light guide member 48 is viewed from the +Y direction toward the −Y direction, the right side surface 48s (see FIG. 5) of the prism-based light guide member 48 in the virtual image display apparatus 100A, 100B according to an embodiment is rotated clockwise by the angle γr compared to the right side surface 48r (see FIG. 3) of the prism-based light guide member 48 in the virtual image display apparatus 1000 according to the related art. Similarly, as shown in FIGS. 3 and 5, when the prism-based light guide member 48 is viewed from the +Y direction toward the −Y direction, the left side surface 48m (see FIG. 6) of the prism-based light guide member 48 in the virtual image display apparatus 100A, 100B according to an embodiment is rotated counterclockwise by the angle γl compared to the left side surface 48l (see FIG. 4) of the prism-based light guide member 48 in the virtual image display apparatus 1000 according to the related art. As a result, at least light from the second flat-plate member 50 is excluded from the unnecessary light UL that can reach the eye EY through the aperture PPa at the pupil position PP.

Here, the +Z-axis direction is a direction from the eye EY of the wearer US toward the second lens 53 along the optical axis AX of the second lens 53. Further, the Y-Z plane is a virtual plane orthogonal to the X-axis direction in which both eyes EY of the wearer US are arranged.

As an example, the width in the X-axis direction of the prism-based light guide member 48 is 22 mm, and the thickness in the Z-axis direction is 6 mm. These numerical values are illustrative only, and do not limit the present embodiment.

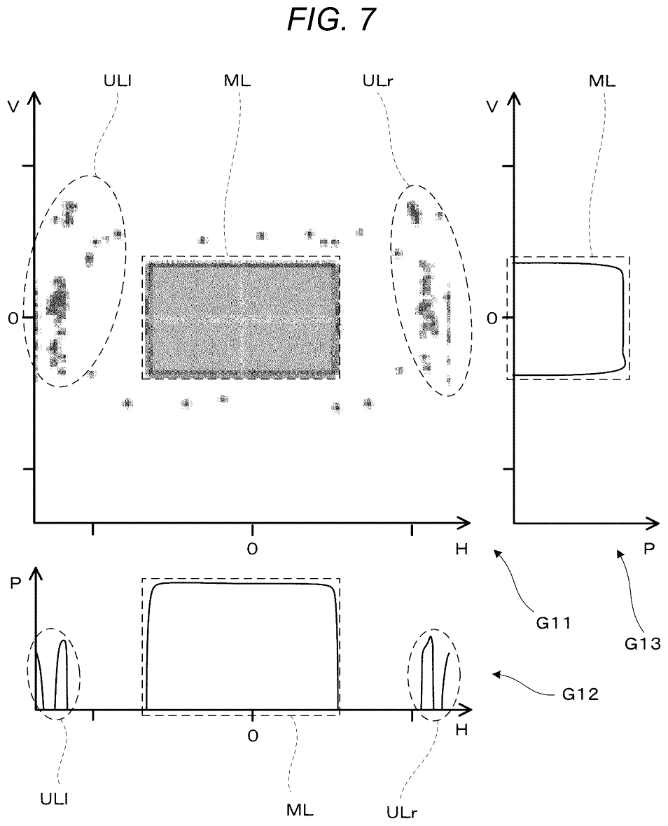

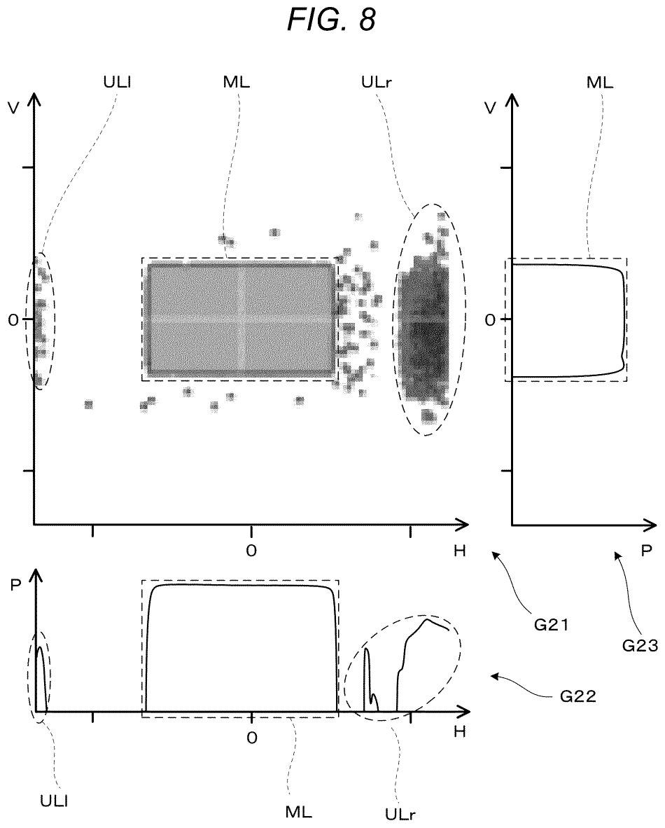

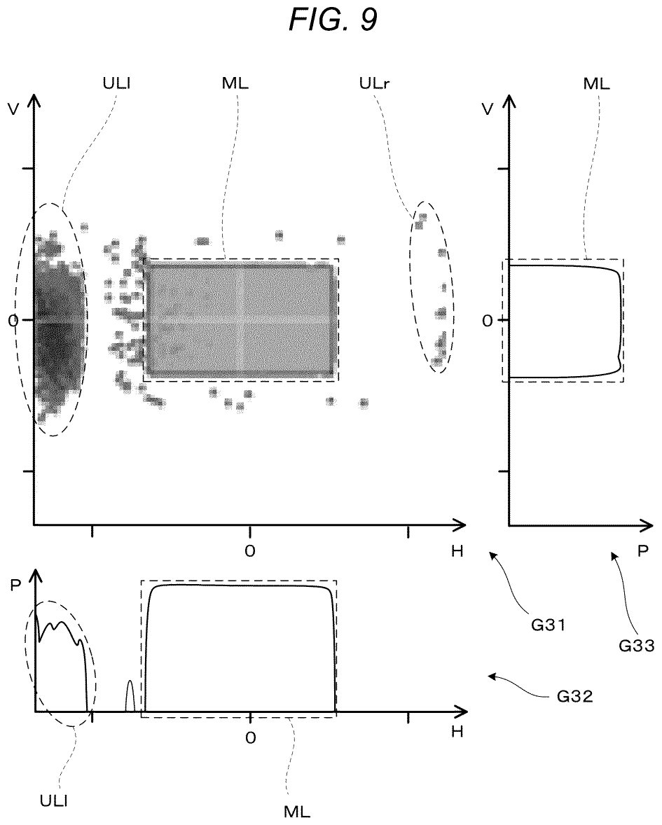

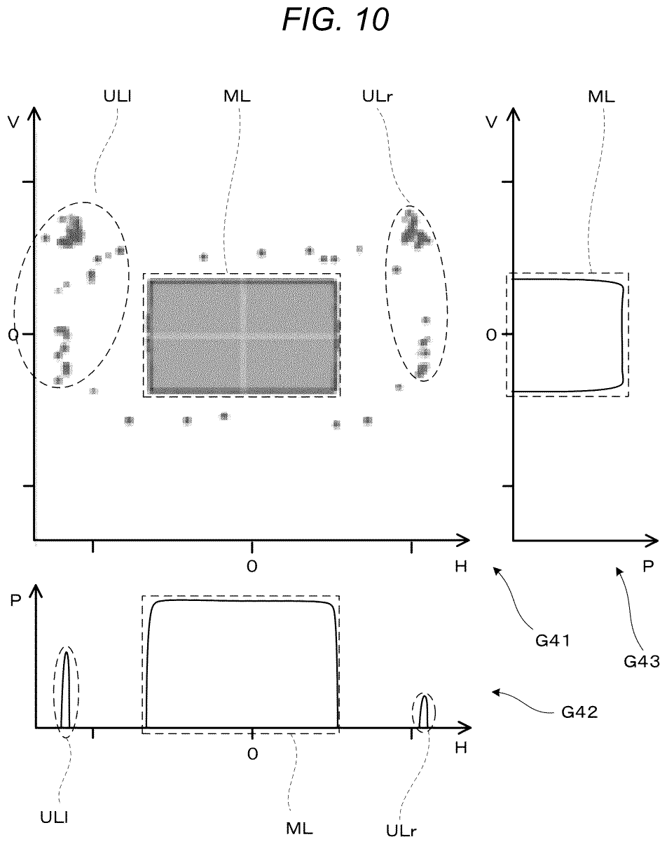

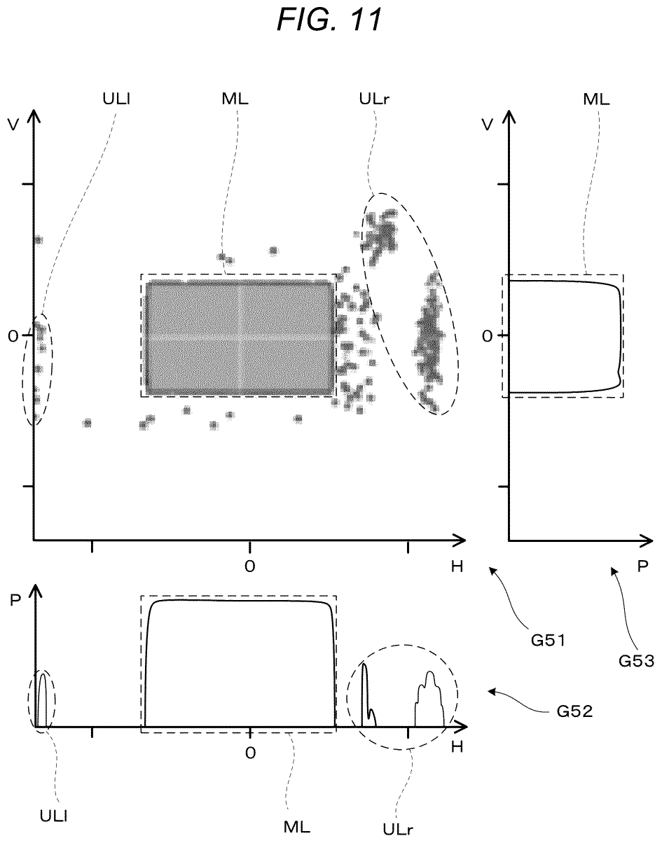

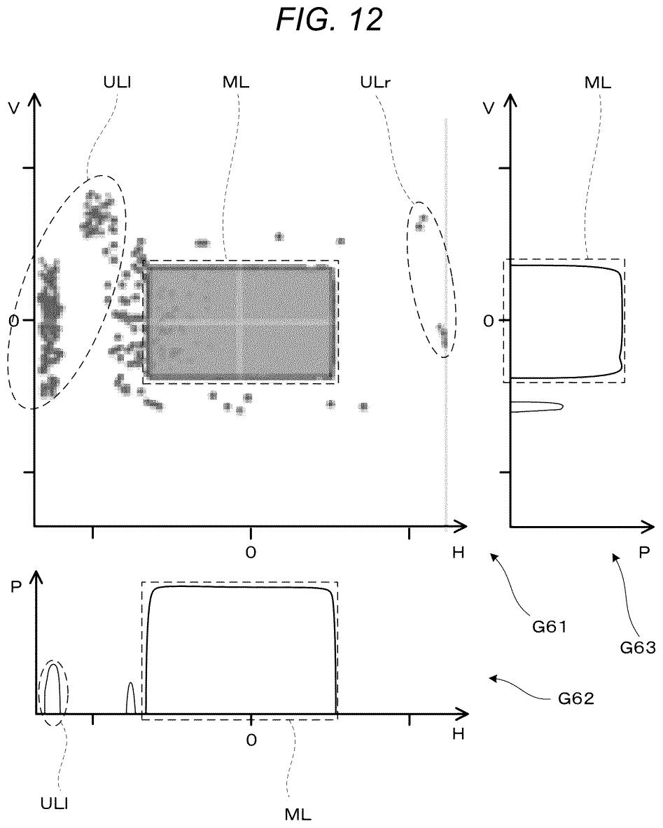

Referring to FIGS. 7, 8, 9, 10, 11, and 12, it will be described that the unnecessary light UL can be reduced by inclining the right side surface 48s and the left side surface 48m with respect to the Y-Z plane. FIGS. 7, 8, and 9 are diagrams illustrating results of a computer simulation conducted on luminance distributions of the image light ML and the unnecessary light UL observed by the eye EY when the virtual image display apparatus 1000 according to the related art illustrated in FIGS. 3 and 4 is used. FIGS. 10, 11, and 12 are diagrams illustrating results of a computer simulation conducted on luminance distributions of the image light ML and the unnecessary light UL observed by the eye EY when the virtual image display apparatus 100A, 100B according to an embodiment illustrated in FIGS. 5 and 6 is used. FIGS. 7 and 10 are diagrams when the optical axis AX corresponds to the center of the eye EY in the X direction. FIGS. 8 and 11 are diagrams when the optical axis AX is on the left side (+X direction) of the center of the eye EY in the X direction. FIGS. 9 and 12 are diagrams when the optical axis AX is on the right side (−X direction) of the center of the eye EY in the X direction.

FIG. 7 includes a graph G11 representing luminance distributions of the image light ML and the unnecessary light ULr, ULl observed in the eye EY when the virtual image display apparatus 1000 according to the related art emits the image light ML in the horizontal (H) axis and the vertical (V) axis of the eye box of the eye EY, a graph G12 representing the luminance distribution thereof in the horizontal (H) axis, and a graph G13 representing the luminance distribution thereof in the vertical (V) axis. In the graph G11, the horizontal axis represents the horizontal (H) axis of the eye box of the eye EY, and the vertical axis represents the vertical (V) axis of the eye box. In the graph G12, the horizontal axis represents the horizontal (H) axis of the eye box of the eye EY, and the vertical axis represents rates of the luminance of the image light ML and the luminance of the unnecessary light ULr, ULl assuming the luminance of the image light ML as 100% in an exponential notation. In the graph G13, the vertical axis represents the vertical (V) axis of the eye box of the eye EY, and the horizontal axis represents rates of the luminance of the image light ML and the luminance of the unnecessary light ULr, ULl assuming the luminance of the image light ML as 100% in an exponential notation.

Similarly, FIG. 10 includes a graph G41 representing luminance distributions of the image light ML and the unnecessary light UL observed in the eye EY when the virtual image display apparatus 100A, 100B according to an embodiment emits the image light ML in the horizontal (H) axis and the vertical (V) axis of the eye box of the eye EY, a graph G42 representing the luminance distribution thereof in the horizontal (H) axis, and a graph G43 representing the luminance distribution thereof in the vertical (V) axis. In the graph G41, the horizontal axis represents the horizontal (H) axis of the eye box of the eye EY, and the vertical axis represents the vertical (V) axis of the eye box. In the graph G42, the horizontal axis represents the horizontal (H) axis of the eye box of the eye EY, and the vertical axis represents rates of the luminance of the image light ML and the luminance of the unnecessary light ULr, ULl assuming the luminance of the image light ML as 100% in an exponential notation. In the graph G43, the vertical axis represents the vertical (V) axis of the eye box of the eye EY, and the horizontal axis represents rates of the luminance of the image light ML and the luminance of the unnecessary light ULr, ULl assuming the luminance of the image light ML as 100% in an exponential notation.

In common to the graphs G11, G12, and G13 in FIG. 7 and the graphs G41, G42, and G43 in FIG. 10, when the optical axis AX corresponds to the center of the eye EY, the luminance of the unnecessary light ULr and luminance of the unnecessary light ULl are sufficiently lower than the luminance of the image light ML. Further, in the eye box of the eye EY, areas occupied by the unnecessary light ULr, ULl are at a sufficient distance from an area occupied by the image light ML, and are sufficiently narrower than the area occupied by the image light ML. On that basis, in FIG. 10, the unnecessary light ULr, ULl is further reduced compared to the case of FIG. 7.

FIG. 8 includes a graph G21 representing luminance distributions of the image light ML and the unnecessary light ULr, ULl observed in the eye EY when the virtual image display apparatus 1000 according to the related art emits the image light ML in the horizontal (H) axis and the vertical (V) axis of the eye box of the eye EY, a graph G22 representing the luminance distribution thereof in the horizontal (H) axis, and a graph G23 representing the luminance distribution thereof in the vertical (V) axis. In the graph G21, the horizontal axis represents the horizontal (H) axis of the eye box of the eye EY, and the vertical axis represents the vertical (V) axis of the eye box. In the graph G22, the horizontal axis represents the horizontal (H) axis of the eye box of the eye EY, and the vertical axis represents rates of the luminance of the image light ML and the luminance of the unnecessary light ULr, ULl assuming the luminance of the image light ML as 100% in an exponential notation. In the graph G23, the vertical axis represents the vertical (V) axis of the eye box of the eye EY, and the horizontal axis represents rates of the luminance of the image light ML and the luminance of the unnecessary light ULr, ULl assuming the luminance of the image light ML as 100% in an exponential notation.

Similarly, FIG. 11 includes a graph G51 representing luminance distributions of the image light ML and the unnecessary light UL observed in the eye EY when the virtual image display apparatus 100A, 100B according to an embodiment emits the image light ML in the horizontal (H) axis and the vertical (V) axis of the eye box of the eye EY, a graph G52 representing the luminance distribution thereof in the horizontal (H) axis, and a graph G53 representing the luminance distribution thereof in the vertical (V) axis. In the graph G51, the horizontal axis represents the horizontal (H) axis of the eye box of the eye EY, and the vertical axis represents the vertical (V) axis of the eye box. In the graph G52, the horizontal axis represents the horizontal (H) axis of the eye box of the eye EY, and the vertical axis represents rates of the luminance of the image light ML and the luminance of the unnecessary light ULr, ULl assuming the luminance of the image light ML as 100% in an exponential notation. In the graph G53, the vertical axis represents the vertical (V) axis of the eye box of the eye EY, and the horizontal axis represents rates of the luminance of the image light ML and the luminance of the unnecessary light ULr, ULl assuming the luminance of the image light ML as 100% in an exponential notation.

As shown in the graphs G21, G22 in FIG. 8, when the virtual image display apparatus 1000 according to the related art emits the image light ML and the optical axis AX corresponds to the left side (+X direction) of the center of the eye EY in the X direction, non-negligible unnecessary light ULr may be observed in some cases at the right side (+H direction, −X direction) of the eye box of the eye EY. As an example of the result of the computer simulation illustrated in FIG. 8, the luminance of the unnecessary light ULr was about 5.3% of the luminance of the image light ML. In contrast, by inclining the right side surface 48r of the prism-based light guide member 48 of the virtual image display apparatus 1000 according to the related art illustrated in FIGS. 3 and 4 to form the right side surface 48s of the virtual image display apparatus 100A, 100B according to an embodiment illustrated in FIGS. 5 and 6, that is, when the virtual image display apparatus 100A, 100B according to an embodiment emits the image light ML and the optical axis AX corresponds to the left side (+X direction) of the center of the eye EY in the X direction, the unnecessary light ULr observed at the right side (+H direction, −X direction) of the eye box of the eye EY is dramatically reduced compared to the case of FIG. 8 as illustrated in graphs G51, G52 of FIG. 11. As an example of the result of the computer simulation illustrated in FIG. 11, the luminance of the unnecessary light ULr was about 0.1% of the luminance of the image light ML.

FIG. 9 includes a graph G31 representing luminance distributions of the image light ML and the unnecessary light ULr, ULl observed in the eye EY when the virtual image display apparatus 1000 according to the related art emits the image light ML in the horizontal (H) axis and the vertical (V) axis of the eye box of the eye EY, a graph G32 representing the luminance distribution thereof in the horizontal (H) axis, and a graph G33 representing the luminance distribution thereof in the vertical (V) axis. In the graph G31, the horizontal axis represents the horizontal (H) axis of the eye box of the eye EY, and the vertical axis represents the vertical (V) axis of the eye box. In the graph G32, the horizontal axis represents the horizontal (H) axis of the eye box of the eye EY, and the vertical axis represents rates of the luminance of the image light ML and the luminance of the unnecessary light ULr, ULl assuming the luminance of the image light ML as 100% in an exponential notation. In the graph G33, the vertical axis represents the vertical (V) axis of the eye box of the eye EY, and the horizontal axis represents rates of the luminance of the image light ML and the luminance of the unnecessary light ULr, ULl assuming the luminance of the image light ML as 100% in an exponential notation.

Similarly, FIG. 12 includes a graph G61 representing luminance distributions of the image light ML and the unnecessary light UL observed in the eye EY when the virtual image display apparatus 100A, 100B according to an embodiment emits the image light ML in the horizontal (H) axis and the vertical (V) axis of the eye box of the eye EY, a graph G62 representing the luminance distribution thereof in the horizontal (H) axis, and a graph G63 representing the luminance distribution thereof in the vertical (V) axis. In the graph G61, the horizontal axis represents the horizontal (H) axis of the eye box of the eye EY, and the vertical axis represents the vertical (V) axis of the eye box. In the graph G62, the horizontal axis represents the horizontal (H) axis of the eye box of the eye EY, and the vertical axis represents rates of the luminance of the image light ML and the luminance of the unnecessary light ULr, ULl assuming the luminance of the image light ML as 100% in an exponential notation. In the graph G63, the vertical axis represents the vertical (V) axis of the eye box of the eye EY, and the horizontal axis represents rates of the luminance of the image light ML and the luminance of the unnecessary light ULr, ULl assuming the luminance of the image light ML as 100% in an exponential notation.

As shown in the graphs G31, G32 in FIG. 9, when the virtual image display apparatus 1000 according to the related art emits the image light ML and the optical axis AX corresponds to the right side (−X direction) of the center of the eye EY in the X direction, non-negligible unnecessary light ULl may be observed in some cases at the left side (−H direction, +X direction) of the eye box of the eye EY. As an example of the result of the computer simulation illustrated in FIG. 9, the luminance of the unnecessary light ULl was about 5.3% of the luminance of the image light ML. In contrast, by inclining the left side surface 48l of the prism-based light guide member 48 of the virtual image display apparatus 1000 according to the related art illustrated in FIGS. 3 and 4 to form the left side surface 48m of the virtual image display apparatus 100A, 100B according to an embodiment illustrated in FIGS. 5 and 6, that is, when the virtual image display apparatus 100A, 100B according to an embodiment emits the image light ML and the optical axis AX corresponds to the right side (−X direction) of the center of the eye EY in the X direction, the unnecessary light ULl observed at the left side (−H direction, +X direction) of the eye box of the eye EY is dramatically reduced compared to the case of FIG. 9 as illustrated in graphs G61, G62 of FIG. 12. As an example of the result of the computer simulation illustrated in FIG. 12, the luminance of the unnecessary light ULl was about 0.1% of the luminance of the image light ML.

The virtual image display apparatus 100A, 100B or the optical unit 100 according to the first embodiment described above is the direct virtual image-type virtual image display apparatus 100A, 100B or the optical unit 100, including the display element 11 configured to emit the image light ML, the first prism 41 on which the image light ML from the display element 11 is incident, the second prism 42 bonded to the first prism 41 to form a prism-based light guide member 48 having a parallel flat plate shape, the semi-transmissive reflection film 45 disposed in a junction portion between the first prism 41 and the second prism 42 and configured to reflect the image light ML guided in the first prism 41, the second lens 53 as a first lens having a planoconvex shape and disposed so as to face the outer side surface 41c of the first prism 41 on which the image light ML reflected by the semi-transmissive reflection film 45 is incident, the transmissive mirror 56 formed at a convex surface of the second lens 53 as the first lens and configured to reflect, toward the semi-transmissive reflection film 45, a part of the image light ML reflected by the semi-transmissive reflection film 45, and the quarter-wave plate 51 disposed between the outer side surface 41c of the first prism 41 and the second lens 53 as the first lens with an air gap, in which out of the surfaces of the prism-based light guide member 48, the right side surface 48s, 41s, and 42s or the left side surface 48m, 41m, and 42m as the third surface in contact with the inclined surface 41a as the first surface on which the image light ML from the display element 11 is incident, and the outer side surface 48c, 41c, and 42c as the second surface facing the second lens 53 as the first lens is inclined with respect to the virtual first plane orthogonal to the first direction in which both eyes EX of the wearer are arranged.

According to the virtual image display apparatus 100A, 100B or the optical unit 100 according to the first embodiment, it is possible to reduce the unnecessary light ULr, ULl that reaches the eye EY by inclining the right side surface 48s and the left side surface 48m of the prism-based light guide member 48 with respect to the Y-Z plane orthogonal to the X-axis direction in which both eyes EX of the wearer are arranged without using the black paint that may cause loss of the external light OL. The inclination may be provided in a rotational direction around the Y-axis direction orthogonal to the Z-axis direction which is the front-rear direction when viewed from the wearer US and the X-axis direction in which both eyes EY of the wearer US are arranged.

### Second Embodiment

In the first embodiment described above, as illustrated in FIGS. 5 and 6, the configuration in which the right side surface 48s and the left side surface 48m of the prism-based light guide member 48 are inclined with respect to the Y-Z plane to thereby reduce the unnecessary light ULr, ULl that reaches the eye EY has been described. In the second embodiment, a configuration adopted when assembly contact surfaces for accurately fixing the virtual image display apparatus 100A, 100B to an external part such as a lens barrel while reducing the unnecessary light ULr, ULl that reaches the eye EY are provided to the right side surface 48s and the left side surface 48m of the prism-based light guide member 48 will be described. The assembly contact surface includes at least one of a contact surface and a reference surface. The contact surface is disposed so as to come into contact with the external part in order to fix the prism-based light guide member 48 to the external part. The reference surface has a shape complementary to the external part in order to adjust a position and a direction with respect to the external part.

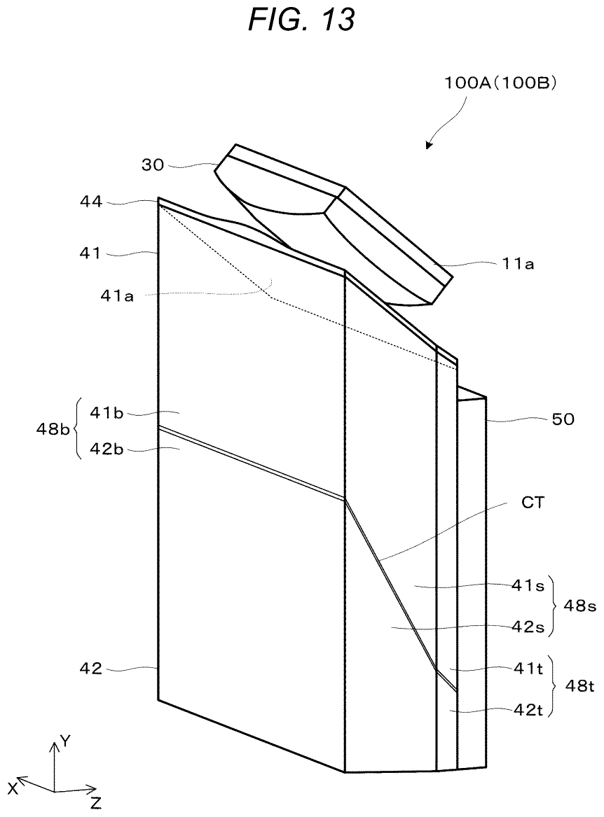

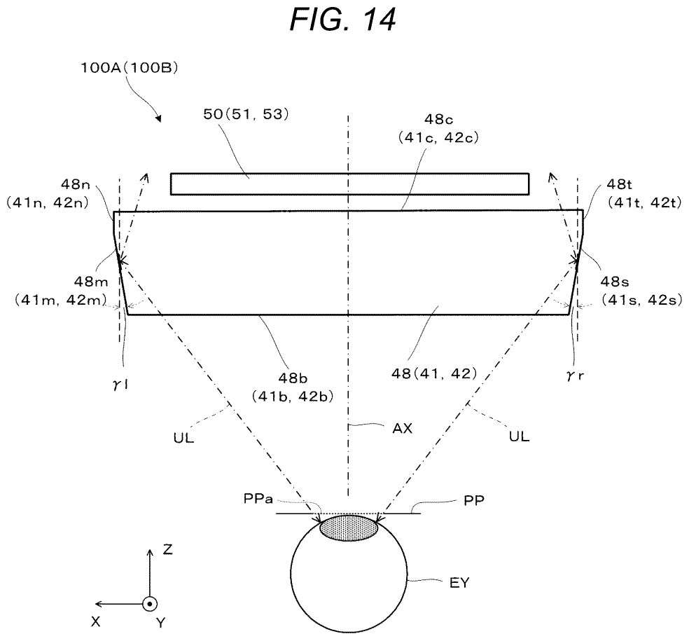

FIG. 13 is a conceptual perspective view of virtual image display apparatus 100A, 100B according to the second embodiment. FIG. 14 is a conceptual cross-sectional view of the virtual image display apparatus 100A, 100B illustrated in FIG. 13. The virtual image display apparatus 100A, 100B illustrated in FIGS. 13 and 14 is obtained by adding the following modifications to the virtual image display apparatus 100A, 100B according to the first embodiment illustrated in FIGS. 5 and 6. That is, the assembly contact surface 48t parallel to the Y-Z plane is provided to a part of the right side surface 48s of the prism-based light guide member 48 illustrated in FIGS. 5 and 6. Further, the assembly contact surface 48n parallel to the Y-Z plane is provided to a part of the left side surface 48m of the prism-based light guide member 48 illustrated in FIGS. 5 and 6.

Note that since the right side surface 48s of the prism-based light guide member 48 includes the right side surface 41s of the first prism 41 and the right side surface 42s of the second prism 42, the assembly contact surface 41t may be provided to the right side surface 41s of the first prism 41 as a part of the assembly contact surface 48t, or the assembly contact surface 42t may be provided to the right side surface 42s of the second prism 42 as a part of the assembly contact surface 48t depending on the position of the assembly contact surface 48t. Similarly, since the left side surface 48m of the prism-based light guide member 48 includes the left side surface 41m of the first prism 41 and the left side surface 42m of the second prism 42, the assembly contact surface 41n may be provided to the left side surface 41m of the first prism 41 as a part of the assembly contact surface 48n, or the assembly contact surface 42n may be provided to the left side surface 42m of the second prism 42 as a part of the assembly contact surface 48n depending on the position of the assembly contact surface 48n.

Since the virtual image display apparatus 100A, 100B or the optical unit 100 according to the second embodiment described above has the right side surface 48s and the left side surface 48m inclined with respect to the Y-Z plane and the assembly contact surfaces 48t, 48n having the surfaces parallel to the Y-Z plane, it is possible to accurately fix the virtual image display apparatus 100A, 100B or the optical unit 100 to an external part such as a lens barrel while reducing the unnecessary light ULr, ULl that reaches the eye EY.

A virtual image display apparatus in a specific aspect is a direct virtual image-type virtual image display apparatus including a display element configured to emit image light, a first prism on which the image light from the display element is incident, a second prism bonded to the first prism to form a prism-based light guide member having a parallel flat plate shape, a semi-transmissive reflection film disposed in a junction portion between the first prism and the second prism and configured to reflect the image light guided in the first prism, a first lens having a planoconvex shape and disposed so as to face an outer side surface of the first prism on which the image light reflected by the semi-transmissive reflection film is incident, a transmissive mirror formed at a convex surface of the first lens and configured to reflect, toward the semi-transmissive reflection film, a part of the image light reflected by the semi-transmissive reflection film, and a quarter-wave plate disposed between the outer side surface of the first prism and the first lens with an air gap, in which out of surfaces of the prism-based light guide member, a third surface in contact with a first surface on which the image light from the display element is incident and a second surface facing the first lens is inclined at a constant angle with a first plane that is a virtual plane perpendicular to a first direction in which eyes of a wearer who wears the virtual image display apparatus are arranged, in a direction in which the prism-based light guide member is tapered toward a direction from the eyes of the wearer toward the first lens along an optical axis of the first lens.

In the virtual image display apparatus in the specific aspect, the third surface is inclined in a rotational direction around a rotational axis parallel to a third direction orthogonal to the first direction and a second direction parallel to a front-back direction of the wearer.

In the virtual image display apparatus according to the specific aspect, out of the surfaces of the prism-based light guide member, a fourth surface that is in contact with the first surface and the second surface and faces the third surface is inclined with respect to the first plane, the prism-based light guide member includes a fifth surface that faces the second surface and is in contact with the first surface, the third surface, and the fourth surface, and each of the third surface and the fourth surface is inclined with respect to the first plane in at least one of a direction of narrowing the fifth surface and a direction of widening the second surface.

In the virtual image display apparatus in the specific aspect, an angle of the third surface or the fourth surface or angles of the third surface and the fourth surface with respect to the first surface fall within a range from 3 degrees to 10 degrees.

In the virtual image display apparatus in the specific aspect, an angle of the third surface or the fourth surface or angles of the third surface and the fourth surface with respect to the first surface fall within a range from 3 degrees to 4 degrees.

In the virtual image display apparatus described above, by inclining the right side surface, the left side surface, or both the right side surface and the left side surface of the prism-based light guide member with respect to the plane orthogonal to the direction in which both eyes of the wearer are arranged, it is possible to reduce unnecessary light that reaches the eye.

The virtual image display apparatus in the specific aspect further includes an assembly contact surface that is in contact with the third surface and includes a sixth surface parallel to the first plane, in which the assembly contact surface includes at least one of a contact surface disposed so as to be in contact with an external part to fix the prism-based light guide member to the external part, and a reference surface having a shape complementary to the external part to adjust a position and a direction of the prism-based light guide member with respect to the external part.

In the virtual image display apparatus described above, since the right side surface, the left side surface, or both the right side surface and the left side surface inclined with respect to the plane orthogonal to the direction in which both eyes of the wearer are arranged and the assembly contact surface having the surface parallel to that plane are provided, it is possible to accurately fix the virtual image display apparatus to the external part such as the lens barrel while reducing the unnecessary light that reaches the eye.

In the virtual image display apparatus in the specific aspect, the first surface includes a second lens on which the image light from the display element is incident, the semi-transmissive reflection film includes a polarization separation film configured to reflect the image light in accordance with a polarization direction of the image light, the second lens, the prism-based light guide member, the polarization separation film, the first lens, the transmissive mirror, and the quarter-wave plate constitute an imaging optical system of a single microscope type that forms an erected image, and the first prism is configured to internally reflect the image light twice while diverging the image light.

In the virtual image display apparatus in the specific aspect, the polarization separation film reflects a first part which is s-polarized light out of the image light that reaches the polarization separation film from the first prism, and transmits the first part which is converted into p-polarized light by being reflected by the transmissive mirror and then being returned through the quarter-wave plate.

The virtual image display apparatus in the specific aspect further includes a compensation lens having a concave surface bonded to the convex surface of the first lens via the transmissive mirror and a surface parallel to the outer side surface of the first prism.

The virtual image display apparatus in the specific aspect further includes a compensation flat plate that is disposed on a periphery of the compensation lens and extends in parallel to the prism-based light guide member.

In the virtual image display apparatus described above, it becomes easy to shorten the distance from the display element to the transmissive mirror, it is possible to reduce the size of the prism-based light guide member, and it is easy to reduce the size of the display element or the first lens.

An optical unit in a specific aspect is a direct virtual image-type optical unit including a display element configured to emit image light, a first prism on which the image light from the display element is incident, a second prism bonded to the first prism to form a prism-based light guide member having a parallel flat plate shape, a semi-transmissive reflection film disposed in a junction portion between the first prism and the second prism and configured to reflect the image light guided in the first prism, a first lens having a planoconvex shape and disposed so as to face an outer side surface of the first prism on which the image light reflected by the semi-transmissive reflection film is incident, a transmissive mirror formed at a convex surface of the first lens and configured to reflect, toward the semi-transmissive reflection film, a part of the image light reflected by the semi-transmissive reflection film, and a quarter-wave plate disposed between the outer side surface of the first prism and the first lens with an air gap, in which out of surfaces of the prism-based light guide member, a third surface in contact with a first surface on which the image light from the display element is incident and a second surface facing the first lens is inclined at a constant angle with a first plane that is a virtual plane perpendicular to a first direction in which eyes of a wearer who wears the optical unit are arranged, in a direction in which the prism-based light guide member is tapered toward a direction from the eyes of the wearer toward the first lens along an optical axis of the first lens.

In the virtual image display apparatus described above, by inclining the right side surface, the left side surface, or both the right side surface and the left side surface of the prism-based light guide member with respect to the plane orthogonal to the direction in which both eyes of the wearer are arranged, it is possible to reduce unnecessary light that reaches the eye.

What is claimed is:

1. A virtual image display apparatus of a direct virtual image-type comprising:
a display element configured to emit image light;
a first prism on which the image light from the display element is incident;
a second prism bonded to the first prism to form a prism-based light guide member having a parallel flat plate shape;
a semi-transmissive reflection film disposed in a junction portion between the first prism and the second prism and configured to reflect the image light guided in the first prism;
a first lens having a planoconvex shape and disposed so as to face an outer side surface of the first prism on which the image light reflected by the semi-transmissive reflection film is incident;
a transmissive mirror formed at a convex surface of the first lens and configured to reflect, toward the semi-transmissive reflection film, a part of the image light reflected by the semi-transmissive reflection film; and
a quarter-wave plate disposed between the outer side surface of the first prism and the first lens with an air gap, wherein
out of surfaces of the prism-based light guide member, a third surface in contact with a first surface on which the image light from the display element is incident and a second surface facing the first lens is configured to be inclined at a constant angle with a first plane that is a virtual plane perpendicular to a first direction in which eyes of a wearer who wears the virtual image display apparatus are arranged, in a direction in which the prism-based light guide member is configured to be tapered toward a direction from the eyes of the wearer toward the first lens along an optical axis of the first lens.

2. The virtual image display apparatus according to claim 1, wherein
the third surface is configured to be inclined in a rotational direction around a rotational axis parallel to a third direction orthogonal to the first direction and a second direction parallel to a front-back direction of the wearer.

3. The virtual image display apparatus according to claim 1, wherein
out of the surfaces of the prism-based light guide member, a fourth surface that is in contact with the first surface and the second surface and faces the third surface is inclined with respect to the first plane,
the prism-based light guide member includes a fifth surface that faces the second surface and is in contact with the first surface, the third surface, and the fourth surface, and
each of the third surface and the fourth surface is inclined with respect to the first plane in at least one of a direction of narrowing the fifth surface and a direction of widening the second surface.

4. The virtual image display apparatus according to claim 3, wherein
an angle of the third surface or the fourth surface or angles of the third surface and the fourth surface with respect to the first surface fall within a range from 3 degrees to 10 degrees.

5. The virtual image display apparatus according to claim 3, wherein
an angle of the third surface or the fourth surface or angles of the third surface and the fourth surface with respect to the first surface fall within a range from 3 degrees to 4 degrees.

6. The virtual image display apparatus according to claim 1, further comprising:
an assembly contact surface that is in contact with the third surface and includes a sixth surface parallel to the first plane, wherein
the assembly contact surface includes at least one of
a contact surface disposed so as to be in contact with an external part to fix the prism-based light guide member to the external part, and
a reference surface having a shape complementary to the external part to adjust a position and a direction of the prism-based light guide member with respect to the external part.

7. The virtual image display apparatus according to claim 1, wherein
the first surface includes a second lens on which the image light from the display element is incident,
the semi-transmissive reflection film includes a polarization separation film configured to reflect the image light in accordance with a polarization direction of the image light,
the second lens, the prism-based light guide member, the polarization separation film, the first lens, the transmissive mirror, and the quarter-wave plate constitute an imaging optical system of a single microscope type that forms an erected image, and
the first prism is configured to internally reflect the image light twice while diverging the image light.

8. The virtual image display apparatus according to claim 7, wherein
the polarization separation film reflects a first part which is s-polarized light out of the image light that reaches the polarization separation film from the first prism, and transmits the first part which is converted into p-polarized light by being reflected by the transmissive mirror and then being returned through the quarter-wave plate.

9. The virtual image display apparatus according to claim 1, further comprising:
a compensation lens having a concave surface bonded to the convex surface of the first lens via the transmissive mirror and a surface parallel to the outer side surface of the first prism.

10. The virtual image display apparatus according to claim 9, further comprising:
a compensation flat plate that is disposed on a periphery of the compensation lens and extends in parallel to the prism-based light guide member.

11. An optical unit of a direct virtual image-type comprising:
a display element configured to emit image light;
a first prism on which the image light from the display element is incident;
a second prism bonded to the first prism to form a prism-based light guide member having a parallel flat plate shape;
a semi-transmissive reflection film disposed in a junction portion between the first prism and the second prism and configured to reflect the image light guided in the first prism;
a first lens having a planoconvex shape and disposed so as to face an outer side surface of the first prism on which the image light reflected by the semi-transmissive reflection film is incident;
a transmissive mirror formed at a convex surface of the first lens and configured to reflect, toward the semi-transmissive reflection film, a part of the image light reflected by the semi-transmissive reflection film; and
a quarter-wave plate disposed between the outer side surface of the first prism and the first lens with an air gap, wherein
out of surfaces of the prism-based light guide member, a third surface in contact with a first surface on which the image light from the display element is incident and a second surface facing the first lens is configured to be inclined at a constant angle with a first plane that is a virtual plane perpendicular to a first direction in which eyes of a wearer who wears the optical unit are arranged, in a direction in which the prism-based light guide member is configured to be tapered toward a direction from the eyes of the wearer toward the first lens along an optical axis of the first lens.
